(19) United States
(12) Patent Application Publication
(10) Pub. No.: US 2017/0147408 A1
(43) Pub. Date: May 25, 2017

(54) COMMON RESOURCE UPDATING APPARATUS AND COMMON RESOURCE UPDATING METHOD

(71) Applicant: Hitachi, Ltd., Tokyo (JP)

(72) Inventor: Norifumi NISHIKAWA, Tokyo (JP)

(21) Appl. No.: 15/300,396

(22) PCT Filed: Apr. 22, 2014
(86) PCT No.: PCT/JP2014/061341

§ 371 Date: Sep. 29, 2016

(51) Int. Cl. G06F 9/50; G06F 9/52

(52) U.S. Cl. CPC G06F 9/5061; G06F 9/52

(57) ABSTRACT

A common resource to be updated is logically divided among the respective threads, and update processing is performed in parallel among a plurality of cores. The common resource updating apparatus comprises a processor which controls an execution of a program configured from a plurality of threads, and updates a common resource including a plurality of areas associated with the plurality of threads, wherein the processor causes at least one thread among the plurality of threads to be an update thread which updates an area of the common resource associated with the thread, and causes a thread that is different from the update thread to be a reference thread which sends an update request to the update thread upon updating the common resource, and directly refers to the common resource upon referring to the common resource.

### TECHNICAL FIELD

The present invention relates to a common resource updating apparatus and a common resource updating method, and can be suitably applied to a common resource updating apparatus and a common resource updating method which control the update of a common resource by a multi-core processor.

### BACKGROUND ART

In recent years, a multi-core processor system which houses a plurality of processor cores (these are hereinafter sometimes simply referred to as “cores”) in one processor package and improves the performance based on parallel processing is being used. A multi-core processor system is operated by the respective cores and respective threads sharing resources (hardware resources).

If an access contention to a common resource occurs among a plurality of threads, threads are stopped according to the priority of the threads, or the thread order is scheduled so that access contention will not occur.

For instance, PTL 1 discloses a technology of avoiding access contention by changing the time that each thread is allocated to the corresponding core upon detecting a state where a plurality of threads are accessing the same resource.

### CITATION LIST

### Patent Literature

PTL 1: Japanese Patent No. 5321748

### SUMMARY OF THE INVENTION

### Problems to be Solved by the Invention

Nevertheless, with PTL 1, while the access contention among threads can be avoided, the state where a plurality of threads are accessing the same resource is not resolved. Thus, despite being equipped with a plurality of cores, the plurality of cores cannot be processes in parallel, and there is a problem in that the update processing performance cannot be improved in proportion to the number of cores.

The present invention was devised in view of the foregoing points, and an object of this invention is to propose a common resource updating apparatus and a common resource updating method capable of logically dividing the common resource to be updated among the respective threads, and performing the update processing in parallel among a plurality of cores.

### Means to Solve the Problems

In order to achieve the foregoing object, the present invention provides a common resource updating apparatus comprises a processor which controls an execution of a program configured from a plurality of threads, and updates a common resource including a plurality of areas associated with the plurality of threads, wherein the processor causes at least one thread among the plurality of threads to be an update thread which updates an area of the common resource associated with the thread, and causes a thread that is different from the update thread to be a reference thread which sends an update request to the update thread upon updating the common resource, and directly refers to the common resource upon referring to the common resource.

Moreover, in order to achieve the foregoing object, the present invention provides a common resource updating method in a common resource updating apparatus which controls an execution of a program configured from a plurality of threads, and updates a common resource including a plurality of areas associated with the plurality of threads, wherein at least one update thread and a plurality of reference threads are included in one thread among the plurality of threads, and the update thread and an area of the common resource to be updated by the update thread are associated, wherein the common resource updating method comprises a step of the reference thread sending an update request to the update thread upon updating the common resource, a step of the reference thread directly referring to the common resource upon referring to the common resource, a step of the update thread storing the sent update request in a data transfer queue, and a step of the update thread updating the areas of the common resource according to an order stored in the data transfer queue.

### Advantageous Effects of the Invention

According to the present invention, it is possible to improve the update processing performance by logically dividing the common resource to be updated among the respective threads, and performing the update processing in parallel among a plurality of cores.

### BRIEF DESCRIPTION OF DRAWINGS

FIG. 1 is a block diagram showing the configuration of a common resource updating system according to one embodiment of the present invention.

FIG. 2 is a block diagram showing the configuration of a host computer according to the same embodiment.

FIG. 3 is a conceptual diagram explaining the contents of a thread status according to the same embodiment.

FIG. 4 is a block diagram showing the configuration of a database management program according to the same embodiment.

FIG. 5 is a block diagram showing the configuration of management data according to the same embodiment.

FIG. 6 is a table showing an example of the DB area management table according to the same embodiment.

FIG. 7 is a table showing an example of the log area management table according to the same embodiment.

FIG. 8 is a table showing an example of the thread management table according to the same embodiment.

FIG. 9 is a table showing an example of the inter-thread data transfer queue according to the same embodiment.

FIG. 10 is a flowchart showing the details of the thread allocation processing according to the same embodiment.

FIG. 11 is a flowchart showing the details of the calculation processing of the number of retrieval sub threads to be generated according to the same embodiment.

FIG. 12 is a flowchart showing the details of the resource allocation processing according to the same embodiment.

FIG. 13 is a flowchart showing the details of the reference DB area allocation processing according to the same embodiment.

FIG. 14 is a flowchart showing the details of the update DB area allocation processing according to the same embodiment.

FIG. 15 is a flowchart showing the details of the log area allocation processing according to the same embodiment.

FIG. 16 is a flowchart showing the sub thread execution control processing according to the same embodiment.

FIG. 17 is a flowchart showing the DB retrieval processing according to the same embodiment.

FIG. 18 is a flowchart showing the DB update processing according to the same embodiment.

FIG. 19 is an explanatory diagram explaining an example of the management screen according to the same embodiment.

### DESCRIPTION OF EMBODIMENTS

An embodiment of the present invention is now explained in detail with reference to the appended drawings.

(1) Configuration of Common Resource Updating System

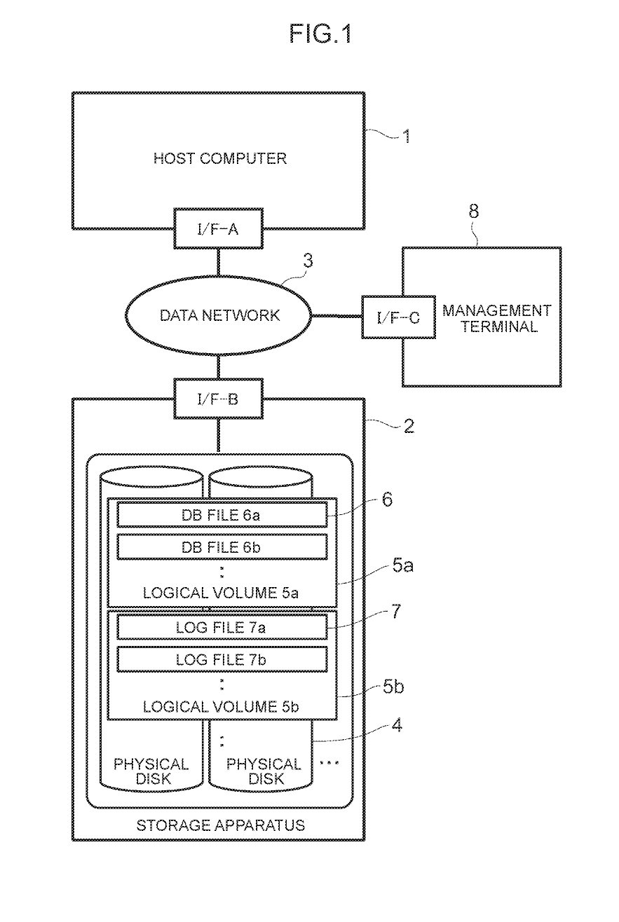

The configuration of the common resource updating system is foremost explained with reference to FIG. 1. As shown in FIG. 1, the common resource updating system is configured by a host computer 1, a storage apparatus 2, and a management terminal 8 being mutually connected via a data network 3.

Note that, in FIG. 1, while only one of each the of apparatuses is connected to the data network 3, the configuration is not limited thereto, and a plurality of each of the apparatuses may also be connected to the data network 3. Moreover, a client terminal (not shown) to be used by a user of an operation system or the like may also be connected to the data network 3.

The host computer 1 is a computer device comprising a CPU (Central Processing Unit), a memory and other information processing resources, and is configured, for example, from a personal computer, a workstation, or a mainframe. The CPU functions as an arithmetic processing unit, and controls the operation of the host computer 1 according to the programs and operational parameters stored in the memory. Note that the host computer 1 is one example of the common resource updating apparatus of the present invention.

Moreover, the host computer 1 adopts a multi-core processor system which houses a plurality of processor cores (cores) in a plurality of CPUs (processor packages; these are hereinafter sometimes simply referred to as “processors”) and improves the performance based on parallel processing. A multi-core processor system is a computer system in which the plurality of cores mounted on the processor share resources (hardware resources), and a plurality of threads are processed in parallel.

Moreover, the host computer 1 is connected to the data network 3 via an I/F-A. The I/F-A controls the data I/O between the host computer 1 and an external apparatus via the data network 3, and a representative example would be a modem or a LAN adapter.

The storage apparatus 2 interprets the command sent from the host computer 1, and executes reading/writing from and to the storage area of the storage apparatus 2. The storage area provided by the storage apparatus 2 is configured from a plurality of physical disks 4.

The storage apparatus 2 defines one or more logical volumes 5a, 5b (these logical volumes 5a, 5b are hereinafter sometimes simply referred to as “logical volume 5”) in the storage area configured from the plurality of physical disks 4. Each logical volume 5 includes database files (indicated as “DB files” in the drawings) 6a, 6b (these are hereinafter sometimes simply referred to as “DB file 6”) and log files 7a, 7b (these are hereinafter sometimes simply referred to as “log file 7”).

Moreover, the storage apparatus 2 is connected to the data network 3 via an I/F-B. The I/F-B controls the data I/O between the storage apparatus 2 and an external apparatus via the data network 3, and a representative example would be a modem or a LAN adapter.

The management terminal 8 is a computer device comprising a CPU, a memory and other information processing resources, and is a computer device which manages the host computer 1 and the storage apparatus 2 according the operator's input. The management terminal 8 comprises an input device such as a keyboard, switch, pointing device or microphone, and an output device such as a monitor display or a speaker.

Moreover, the management terminal 8 is connected to the data network 3 via an I/F-C. The I/F-C controls the data I/O between the management terminal 8 and an external apparatus via the data network 3, and a representative example would be a modem or a LAN adapter.

(2) Configuration of Host Computer

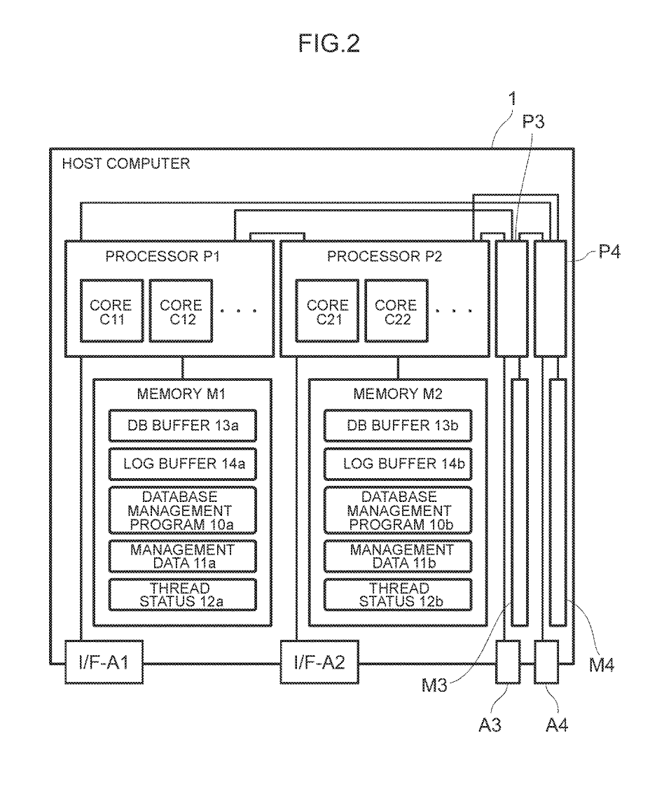

A detailed configuration of the host computer 1, which is an example of the common resource updating apparatus of the present invention, is now explained with reference to FIG. 2. As shown in FIG. 2, the host computer 1 comprises a plurality of processors P1, P2, P3 and P4, and memories M1, M2, M3 and M4 are associated with the respective processors.

Moreover, the respective processors P1, P2, P3 and P4 are each connected to the corresponding memory M1, M2, M3 and M4 via a bus or the like, and the processors P1 to P4 execute the various programs stored in the corresponding memories M1 to M4 and store the changing parameters as needed, or temporarily store various types of data to be stored in the storage apparatus 2.

Each of the respective processors P1 to P4 is equipped with a plurality of cores, and each processor actives the plurality of cores in parallel and processes a plurality of threads in parallel. Each processor P1 to P4 sends and receives data to and from the storage apparatus 2 connected to the data network 3 via the IF-A1 to the IF-A4.

The memory M1 includes a DB buffer 13a, a log buffer 14a, a database management program 10a, management data 11a and a thread status 12a. Note that, since the memories M2 to M4 are configured in the same manner as memory M1, the configuration of the memory M1 will be described in detail in the ensuing explanation.

The DB buffer 13a is an area for temporarily storing the data to be written into the DB file 6 of the storage apparatus 2. Moreover, the log buffer 14a is an area for temporarily storing the data to be written into the log file 7 of the storage apparatus 2.

The database management program 10a is a program which controls the retrieval processing and update processing to be performed to the database (DB file 6). The database management program 10a will be explained in detail later. The management data 11a is information that is used for the database management program 10 to manage the database area (DB file 6), the log area (log file 7) and threads. The management data 11a will be explained in detail later.

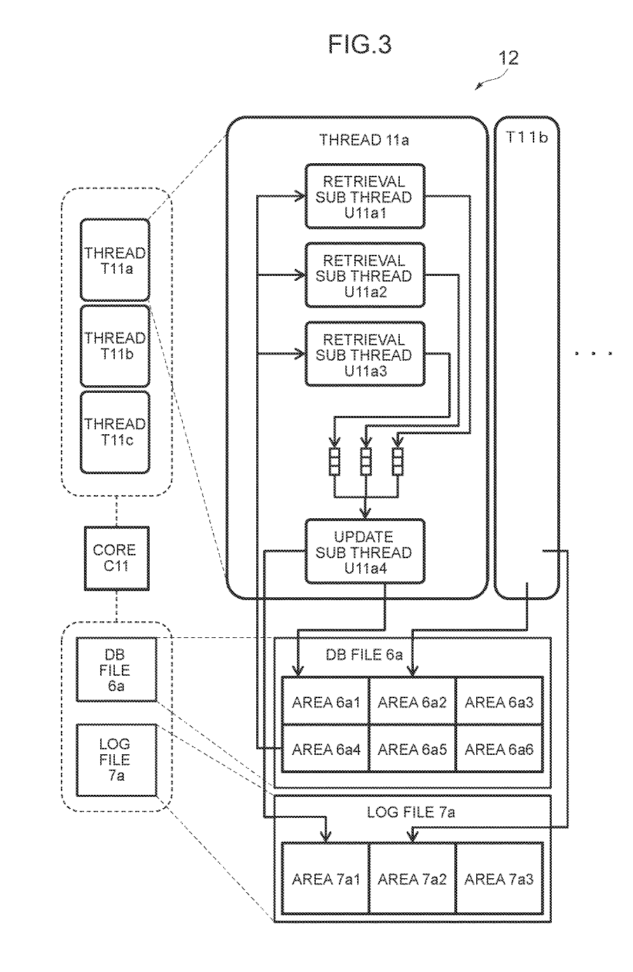

The thread status 12a stores the status information of the thread that is being executed by the respective cores of the processor P1. The thread status 12 is now explained with reference to FIG. 3.

The status of the thread that is being executed by the core C11 of the processor P1 in FIG. 3 is now explained. While the core C11 of the processor P1 will be explained in FIG. 3, the same processing as the core C11 is also executed in the other cores of the processor P1 and in the respective cores of other processors.

In FIG. 3, the threads that are being managed based on the OS (Operating System) managing the hardware of the host computer 1 are indicated as threads T11a, T11b and T11c. Furthermore, the threads that are being managed by database management program 10 as the user program as a result of simulating the subdivision of one thread are indicated as sub threads U11a1, U11a2, U11a3 and U11a4.

The threads T11a, T11b and T11c are executed by the core C11, and the reading/writing of data from or to the DB file 6a or the log file 7a associated with the core C11 is executed.

As described above, one thread is managed by being subdivided into a plurality of sub threads in a simulated manner, and, for instance, when the thread T11a is executed, a plurality of retrieval sub threads U11a1, U11a2 and U11a3, and the update sub thread U11a4 are executed.

For instance, let it be assumed that the OS instructs the core C11 to update a certain area of the DB file 6a or the log file 7a. In the foregoing case, one of the retrieval sub threads U11a1, U11a2, U11a3 retrieve the area to be updated, and requests the update sub thread U11a4 to update the retrieved area. The update sub thread U11a4 that received the update request updates the designated area of the DB file 6a or the log file 7a to be updated.

Each sub thread is associated with a specific area of the DB file 6a or the log file 7a. For example, in FIG. 3, one of the retrieval sub threads U11a1, U11a2, U11a3 is associated with one of the areas 6a4, 6a5, 6a6. Moreover, the update sub thread U11a4 is associated with the area 6a1. Similarly, the area 6a2 and the area 7a2 are associated with the update sub threads of the thread T11b.

As described above, in this embodiment, the threads to be executed by the respective cores are subdivided in a simulated manner, and a specific area of the storage area is associated with each thread. In particular, the sub thread to perform the update is limited to one sub thread among the plurality of sub threads in each thread, and the common resource to be updated is logically divided and associated with the update sub thread. Since it is thereby possible to prevent the plurality of update sub threads from accessing the same area in cases where a plurality of cores access the same resource, the update processing performance can be improved in proportion to the number of cores by performing the update processing in parallel among the cores. Note that the foregoing update sub thread is one example of the update thread of the present invention, and the foregoing retrieval sub thread is one example of the reference thread of the present invention. Moreover, with the retrieval sub thread in this embodiment, while a specific area of the DB file is associated with one retrieval sub thread in the same manner as the update sub thread, the configuration is not limited thereto. For example, the areas of the DB file to be retrieved by a plurality of retrieval sub threads may be overlapping. In the foregoing case, an administrator or the like will be required to designate a specific area of the DB file to be the area to be retrieved upon designing the configuration of the DB file so that the area to be retrieved will not be the area to be updated.

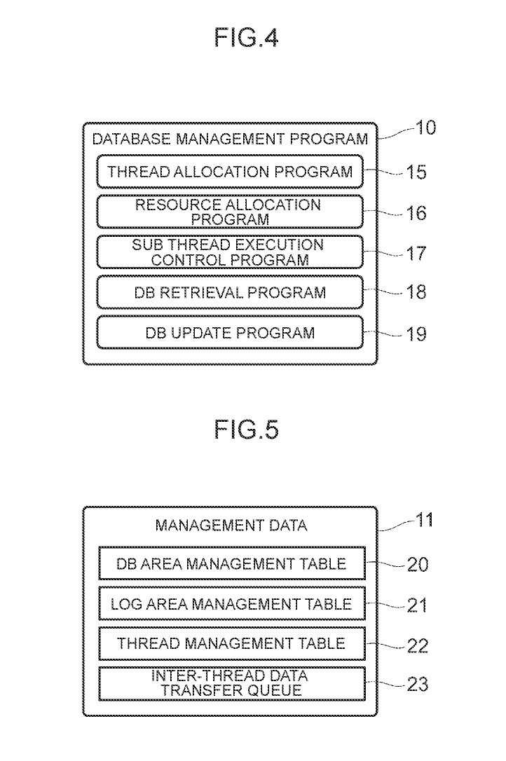

The database management program 10 and the management data 11 of the host computer 1 are now explained in detail with reference to FIG. 4 to FIG. 9.

As shown in FIG. 4, the database management program 10 is configured from a thread allocation program 15, a resource allocation program 16, a sub thread execution control program 17, a DB retrieval program 18 and a DB update program 19.

The thread allocation program 15 is a program which generates a plurality of retrieval sub threads and one update sub thread that is executed by allocating threads to a plurality of CPUs (cores) based on a query execution definition such as an SQL (Structured Query Language), and subdividing each of the threads in a simulated manner. The association of cores, threads and sub threads is managed by the thread management table 22 described later.

The resource allocation program 16 is a program which allocates a specific area of the database to the sub thread generated by the thread allocation program 15. The association of the sub thread allocated by the resource allocation program 16 and the specific area of the database is also managed by the thread management table 22.

The sub thread execution control program 17 is a program which controls the selection of the sub thread to be executed based on the transfer queue information of data between threads of the thread associated with the core.

The DB retrieval program 18 is a program which executes one retrieval sub thread among the plurality of retrieval sub threads, and acquires a record to be retrieved from the DB area which has been allocated to the respective retrieval sub threads.

The DB update program 19 is a program which executes the update sub thread based on the information provided from the retrieval sub thread, and updates the area of the database which has been allocated.

The management data 11 is now explained. As shown in FIG. 5, the management data 11 includes a DB area management table 20, a log area management table 21, a thread management table 22 and an inter-thread data transfer queue 23.

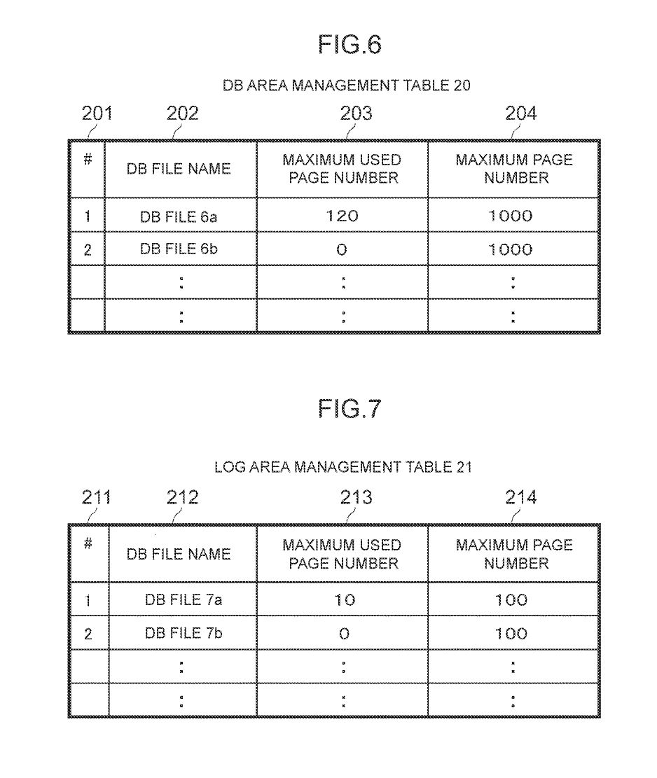

The DB area management table 20 is a table which logically divides the storage area of the plurality of physical disks 4 of the storage apparatus 2, and manages such storage areas as a DB file. As shown in FIG. 6, the DB area management table 20 is configured from a table item number 201, a DB file name 202, a maximum used page number 203 and a maximum page number 204.

The table item number 201 is an item number of the data of the DB area management table 20. The DB file name 202 is the storage area of the plurality of physical disks 4 of the storage apparatus 2, and a file name of the database associated with each core. Moreover, the maximum used page number 203 is a number of the maximum used pages of the area being used among the areas of each DB file. Moreover, the maximum page number 204 is a number of the maximum pages of the areas of each DB file. Here, a “page” is a unit of an area of the physical disk 4 from and to which data is read/written, and a logical volume is configured from a plurality of pages.

In FIG. 6, for instance, it can be understood that the maximum used page number of the DB file 6a is 120, and the maximum page number is 1000. The number 1000 as the maximum page number is a number that is decided when the DB file 6a is generated. Moreover, the number 120 as the maximum used page number is a number that is updated when the DB file 6a is updated based on data update processing or the like.

The log area management table 211 is a table which logically divides the storage area of the plurality of physical disks 4 of the storage apparatus 2, and manages such storage areas as a log file. As shown in FIG. 7, the log area management table 21 is configured from a table item number 211, a log file name 212, a maximum used page number 223 and a maximum page number 214.

The table item number 211 is an item number of the data of the log area management table 21. The log file name 212 is the storage area of the plurality of physical disks 4 of the storage apparatus 2, and a file name of the log associated with each core. Moreover, the maximum used page number 213 is a number of the maximum used pages of the area being used among the areas of each log file. Moreover, the maximum page number 214 is a number of the maximum pages of the areas of each log file.

For example, in FIG. 7, it can be understood that the maximum used page number of the log file 7a is 10, and the maximum page number is 100. The number 100 as the maximum page number is a number that is decided when the log file 7a is generated. Moreover, the number 10 as the maximum used page number is a number that is updated when the log file 7a is updated based on data update processing or the like.

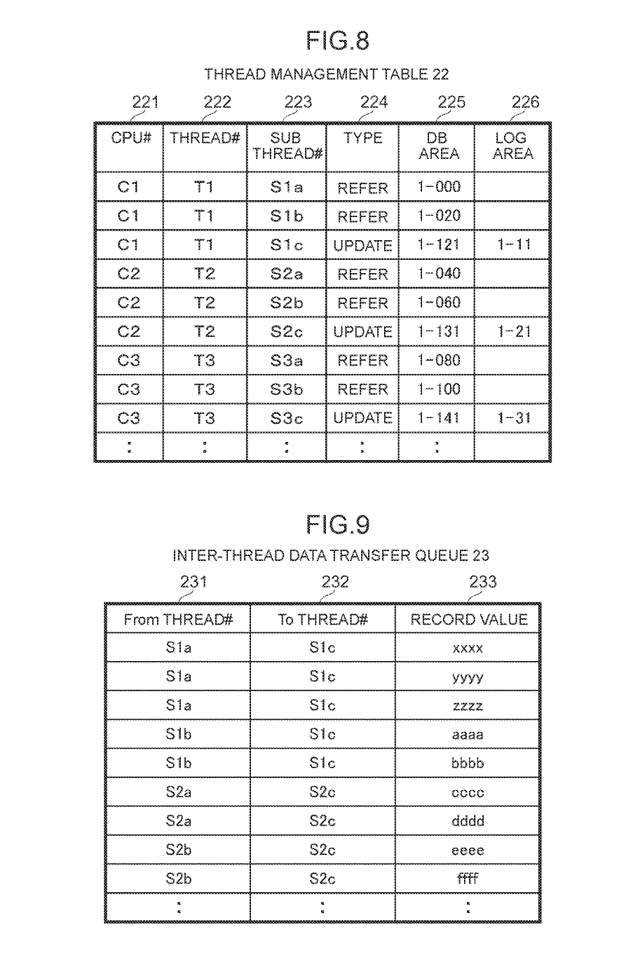

The thread management table 22 is a table which manages the threads and the sub threads that are executed by the CPU of the host computer 1, and is configured, as shown in FIG. 8, from a CPU number (CPU #) 221, a thread number (thread #) 222, a sub thread number (sub thread #) 223, a type 224, a DB area 225 and a log area 226.

The CPU number 221 is a number which identifies the CPU mounted on the host computer 1. The thread number 222 is a number which identifies the thread that is associated with each CPU. The sub thread number 223 is a number which identifies the sub thread that is managed by simulating the subdivision of the respective threads. The type 224 indicates the type of sub thread, and is information indicating whether the sub thread is a reference sub thread or an update sub thread. The DB area 225 is information which identifies the area of the DB file to be referred to or updated by the respective sub threads. The log area 226 is information which identifies the area of the log file to be updated by the update sub thread.

For example, in FIG. 8, the thread T1 is allocated to the CPU having a CPU number of C1, and the thread T1 is subdivided into reference sub threads S1a and S1b, and an update sub thread S1c. Furthermore, it can be understood that the area of the DB file to be referred to by the reference sub thread S1a is 1-000, the area of the DB file to be referred to by the reference sub thread S1b is 1-020, and the area of the DB file to be updated by the update sub thread S1c is 1-121. Moreover, it can be understood that the area of the log file to be updated by the update sub thread S1c is 1-11.

Note that, in FIG. 8, while the designated data of the DB file or the log file is allocated to one update sub thread in advance, the configuration is not limited thereto. For example, it is also possible to pre-set the update amount of the area of the DB file to be allocated to one update sub thread, and allocate another area of the DB file to the update sub thread upon exceeding the foregoing update amount. It is thereby possible to prevent a predetermined area of the DB file or the log file from exceeding a certain update amount.

The inter-thread data transfer queue 23 is a queue which stores the data that is transferred between the sub threads, and associates and stores, as shown in FIG. 9, a sub thread (From thread #) 231 as the data transfer source, a sub thread (To thread #) 232 as the data transfer destination, and a record value 233 of the data to be transferred.

The DB retrieval program 18 stores, in the inter-thread data transfer queue 23, the result of executing the retrieval sub thread and retrieving the database, and the DB update program 19 refers to the inter-thread data transfer queue 23 and executes the designated update sub thread, and thereby updates the database.

For example, in FIG. 9, it can be understood that a record value of xxxx will be transferred from the reference sub thread S1a to the update sub thread S1c. In other words, it can be understood that the result of the DB retrieval program 18 executing the reference sub thread S1a is stored in the inter-thread data transfer queue 23, and the update sub thread S1c is executed by the DB update program 19.

Moreover, when executing a plurality of update sub threads in parallel, the update request to the DB file or the log file may be executed based on the number of update requests of the inter-thread data transfer queue 23 corresponding to the respective update sub threads. For example, an update sub thread with only a few update requests may be executed preferentially.

(3) Common Resource Update Processing

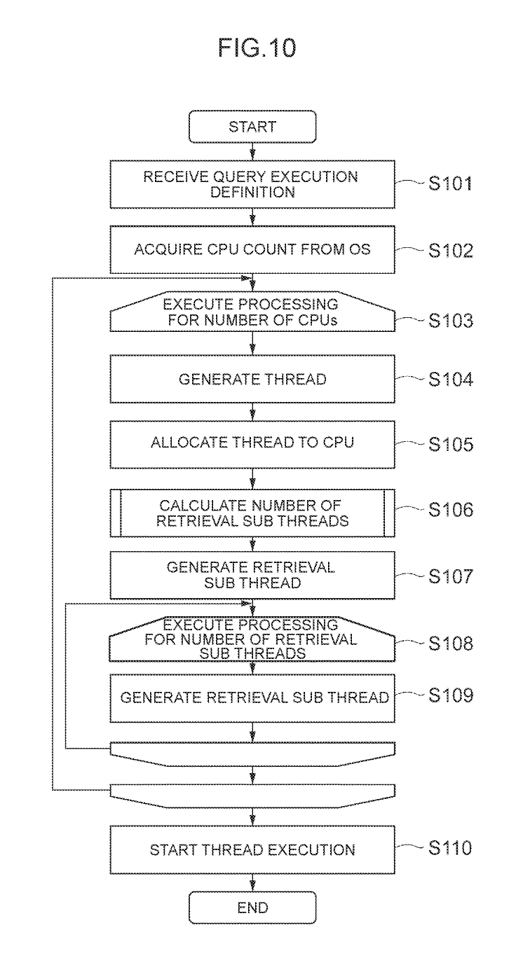

The common resource update processing performed by the host computer 1 is now explained with reference to FIG. 10 to FIG. 18. In the ensuing explanation, while the processing entity of various types of processing is explained as a “program”, it goes without saying that, in effect, the CPU of the host computer 1 executes the processing based on the program.

The thread allocation processing based on the thread allocation program 15 is foremost explained with reference to FIG. 10. In the thread allocation processing, a thread to be managed by the OS is generated, and the generated thread is further subdivided in a simulated manner to generate sub threads.

As shown in FIG. 10, the thread allocation program 15 receives a query execution definition (S101). The query execution definition received in step S101 is a query in which the number of retrieval sub threads to be generated has been defined based on SQL or the like. The number of retrieval sub threads to be generated is set in advance based on the user's input and designated in the query. The number of retrieval sub threads to be generated which is designated based on the query execution definition may be, for example, the maximum number or the minimum number of number of retrieval sub threads to be generated.

The thread allocation program 15 acquires the number of CPUs of the host computer 1 from the OS of the host computer 1 (S102), and executes the processing of step S103 to step S109 for the number of CPUs (S103).

The thread allocation program 15 generates a thread to be managed by the OS of the host computer 1 (S104), and allocates the generated thread to the CPU corresponding to that thread (S105). In step S105, the OS of the host computer 1 decides to which CPU the thread should be allocated.

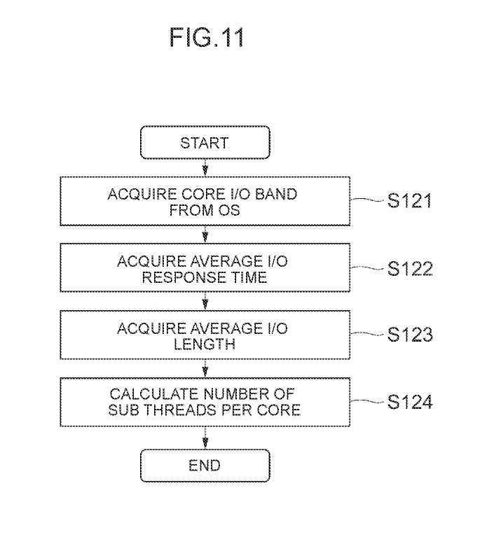

Subsequently, the thread allocation program 15 calculates the number of retrieval sub threads to be generated (S106). The details of the calculation processing of the number of retrieval sub threads to be generated are now explained with reference to FIG. 11.

As shown in FIG. 11, the thread allocation program 15 acquires an I/O band of the core from the OS of the host computer 1 (5121). Furthermore, the thread allocation program 15 acquires an I/O average response time of the core (S122), and acquires an average I/O length of the core (S123).

Subsequently, the thread allocation program 15 calculates the number of retrieval simulated threads per core (S124). Specifically, the thread allocation program 15 calculates the number of retrieval sub threads per core based on Formula (1) below.

Number of retrieval sub threads=core I/O band (Hz)/(I/O average response time (h)×average I/O length (byte)−1 (1)

In the foregoing example, the number of retrieval sub threads per core is calculated in cases where one thread is allocated to one core. Moreover, one sub thread among the plurality of sub threads, which are subdivided within the thread in a simulated manner, is allocated as the update sub thread. For example, when n-number of threads are allocated to one core, the number of retrieval sub threads per thread is calculated based on Formula (2) below.

Number of retrieval sub threads=(core I/O band (Hz)/I/O average response time (h)×average I/O length (byte)−n)/n (2)

Moreover, in the foregoing example, while one sub thread in the thread is used as the update sub thread, a plurality of sub threads may also be used as the update sub thread.

Returning to FIG. 10, the thread allocation program 15 generates an update sub thread (S107). Specifically, the thread allocation program 15 generates one update sub thread for one thread. Moreover, the thread allocation program 15 sets the information of the generated update sub thread in the thread management table 22.

Next, the thread allocation program 15 generates a retrieval sub thread in the number calculated in step S106 (S108, S109). Moreover, the thread allocation program 15 sets the information of the generated retrieval sub thread in the thread management table 22. Accordingly, based on the sub thread generation processing of step S107 to step S109, the CPU number, the thread number, the sub thread number, and information regarding whether the sub thread is for retrieval (referral) or update (update) are associated in the thread management table 22.

Subsequently, the thread allocation program 15 notifies the generation of the sub threads to the OS of the host computer 1, and then starts the execution of the thread (S110).

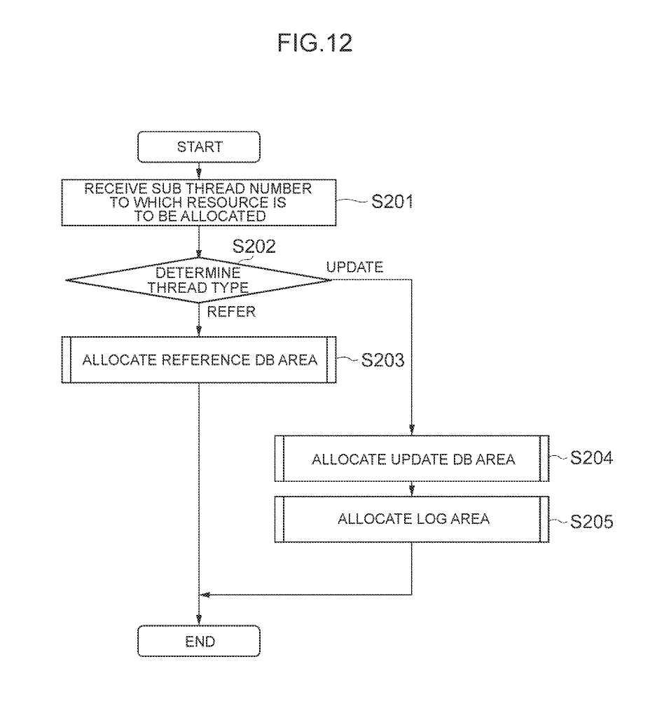

The resource allocation processing based on the resource allocation program 16 is now explained with reference to FIG. 12 to FIG. 15. In the resource allocation processing, the resource of the storage apparatus 2 is allocated to the sub threads generated in the foregoing thread allocation processing.

As shown in FIG. 12, the resource allocation program 16 receives a number of the sub threads to which the resource is to be allocated (S201). In step S201, the resource allocation program 16 receives a number of the generated sub threads from the thread allocation program 15.

The resource allocation program 16 refers to the thread management table 22, and determines whether the type of sub thread corresponding to the number of the sub thread received in step S201 is “referral” or “update” (S202).

When it is determined that the type of sub thread is “referral” in step S202, the resource allocation program 16 executes the reference DB area allocation processing (S203).

Meanwhile, when it is determined that the type of sub thread is “update” in step S202, the resource allocation program 16 executes the update DB area allocation processing (S204) and the log area allocation processing (S205).

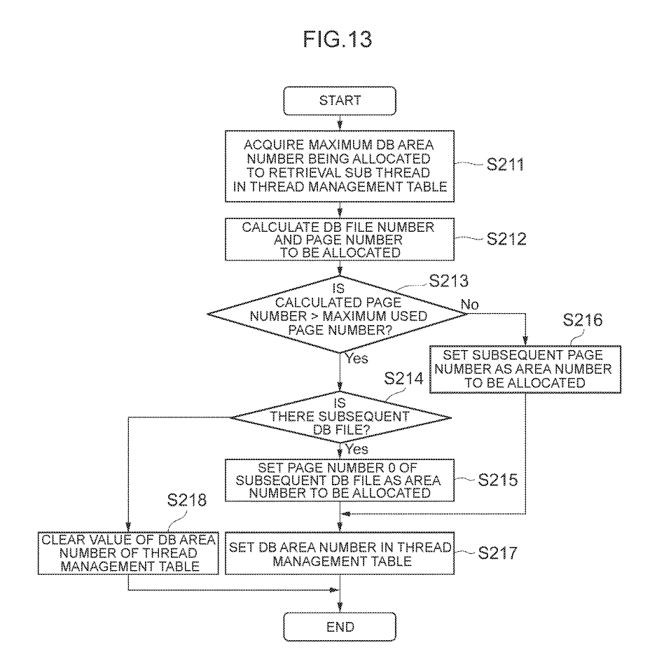

The resource allocation processing in step S203 to step S205 is now explained in detail. FIG. 13 shows the details of the reference DB area allocation processing in step S203. In the reference DB area allocation processing, a reference area among the DB areas is allocated to the sub thread which is allocated to retrieval.

As shown in FIG. 13, the resource allocation program 16 acquires a maximum DB area number which is allocated to the sub thread of the thread management table 22 (S211). The maximum DB area number allocated to the sub thread acquired in step S211 refers to the maximum DB area number of the DB area which is allocated to one thread being managed by the OS.

For example, when a file name has been defined based on SQL or the like, the OS of the host computer 1 comprehends the usage state of the file and the activation status of the thread, divides the file by the number of threads that are active, and calculates the area of the DB file allocated to one thread. The maximum DB area number of the DB file allocated to the one thread is acquired in step S211.

Subsequently, the resource allocation program 16 calculates the number and page number of the DB file to be allocated to the retrieval sub thread (S212). Specifically, the resource allocation program 16 divides the DB area allocated to one thread by the number of sub threads calculated based on the thread allocation processing, and calculates the number and page number of the DB file of the divided DB areas.

Subsequently, the resource allocation program 16 determines whether the page number of the DB file calculated in step S212 is greater than the maximum used page number of the corresponding DB file of the DB area management table 20 (S213).

In step S213, when the page number of the DB file calculated in step S212 is greater than the maximum used page number of the DB area management table 20, this means that there is no area to be allocated to the DB file. Accordingly, when the page number of the DB file calculated in step S212 is greater than the maximum used page number of the DB area management table 20, the resource management program 16 determines whether there is a DB file that can be subsequently allocated (S214).

Meanwhile, in step S213, when the page number of the DB file calculated in step S212 is smaller than the maximum used page number of the DB area management table 20, the resource allocation program 16 uses the next page number of the DB file as the page number to be allocated to the retrieval sub thread (S216).

In step S214, when it is determined that there is a DB file that can be allocated subsequently, the resource allocation program 16 uses the next page number of the DB file as the page number to be allocated to the retrieval sub thread (S215).

Subsequently, the resource allocation program 16 sets, in the DB area 225 of the retrieval sub thread to which the DB area of the thread management table 22 was allocated, the DB area number corresponding to the page number that was allocated in step S215 or step S216 (S217).

Meanwhile, when it is determined in step S214 that there is no DB file that can be allocated subsequently, the resource allocation program 16 clears the value of the DB area number of the thread management table (S218).

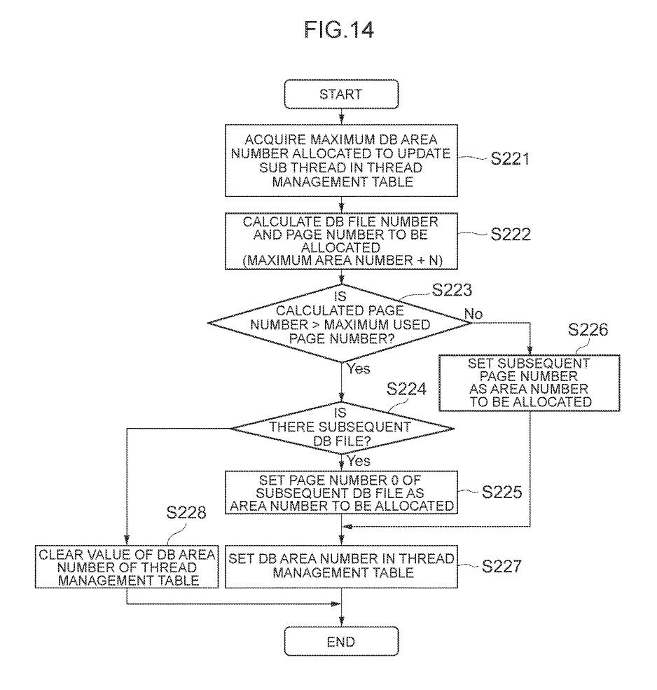

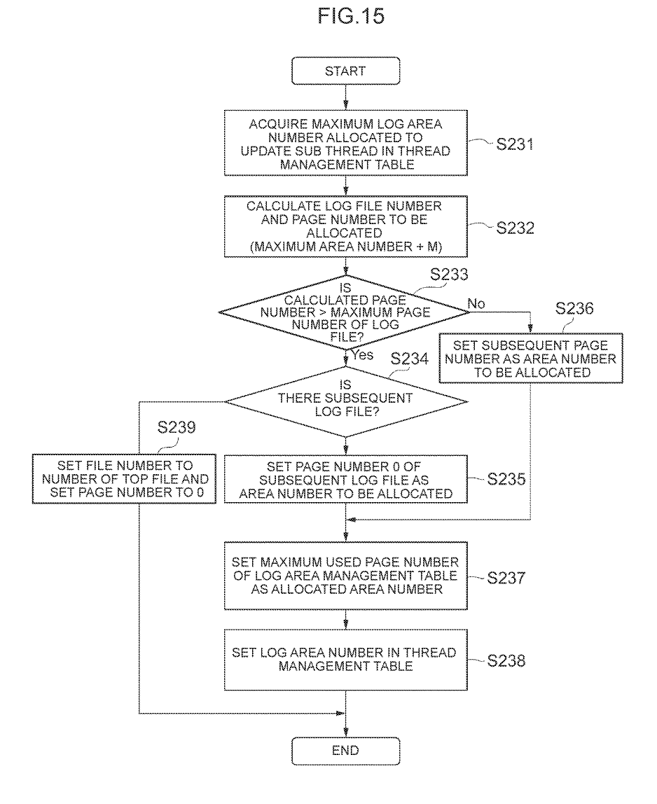

The update DB area allocation processing in step S204 is now explained in detail with reference to FIG. 14. In the update DB area allocation processing, an update DB area among the DB areas is allocated to the sub thread which is allocated as an update sub thread.

As shown in FIG. 14, the resource allocation program 16 acquires a maximum DB area number which is allocated to the sub thread of the thread management table 22 (S221). The maximum DB area number allocated to the sub thread acquired in step S221 refers to the maximum DB area number of the DB area which is allocated to one thread being managed by the OS.

Subsequently, the resource allocation program 16 calculates the number and page number of the DB file to be allocated to the update sub thread (S222). Specifically, the resource allocation program 16 divides the DB area allocated to one thread by the number of sub threads calculated based on the thread allocation processing, and calculates the number and page number of the DB file of the divided DB areas.

Subsequently, the resource allocation program 16 adds the area number N corresponding to the DB area, which was allocated to the update sub thread, to the maximum DB area number acquired in step S221. Consequently, since the DB area of an area number in which N is added to the maximum area number is allocated in cases where the DB area is allocated to another update sub thread, it is possible to prevent another update sub thread from being allocated to the DB area calculated in step S222.

Subsequently, the resource allocation program 16 determines whether the page number of the DB file calculated in step S222 is greater than the maximum used page number of the corresponding DB file of the DB area management table 20 (S223).

In step S223, when the page number of the DB file calculated in step S222 is greater than the maximum used page number of the DB area management table 20, this means that there is no area to be allocated to the DB file. Accordingly, when the page number of the DB file calculated in step S222 is greater than the maximum used page number of the DB area management table 20, the resource management program 16 determines whether there is a DB file that can be subsequently allocated (S224).

Meanwhile, in step S223, when the page number of the DB file calculated in step S212 is smaller than the maximum used page number of the DB area management table 20, the resource allocation program 16 uses the next page number of the DB file as the page number to be allocated to the update sub thread (S226).

In step S224, when it is determined that there is a DB file that can be allocated subsequently, the resource allocation program 16 uses the next page number of the DB file as the page number to be allocated to the update sub thread (S225).

Subsequently, the resource allocation program 16 sets, in the DB area 225 of the update sub thread to which the DB area of the thread management table 22 was allocated, the DB area number corresponding to the page number that was allocated in step S215 or step S216 (S227).

Meanwhile, when it is determined in step S224 that there is no DB file that can be allocated subsequently, the resource allocation program 16 clears the value of the DB area number of the thread management table (S228).

The log area allocation processing in step S205 is now explained in detail with reference to FIG. 15. In the log area allocation processing, a log DB area among the DB areas is allocated to the sub thread which is allocated as an update sub thread.

As shown in FIG. 15, the resource allocation program 16 acquires a maximum log area number which is allocated to the sub thread of the thread management table 22 (S231). The maximum log area number allocated to the sub thread acquired in step S231 refers to the maximum log area number of the log area which is allocated to one thread being managed by the OS.

Subsequently, the resource allocation program 16 calculates the number and page number of the log file to be allocated to the update sub thread (S232). Specifically, the resource allocation program 16 divides the log area allocated to one thread by the number of sub threads calculated based on the thread allocation processing, and calculates the number and page number of the log file of the divided log areas.

Subsequently, the resource allocation program 16 adds the area number M corresponding to the log area, which was allocated to the update sub thread, to the maximum log area number acquired in step S231. Consequently, since the log area of an area number in which M is added to the maximum area number is allocated in cases where the log area is allocated to another update sub thread, it is possible to prevent another update sub thread from being allocated to the log area calculated in step S232.

Subsequently, the resource allocation program 16 determines whether the page number of the log file calculated in step S232 is greater than the maximum used page number of the corresponding log file of the log area management table 21 (S233).

In step S233, when the page number of the log file calculated in step S212 is greater than the maximum used page number of the log area management table 21, this means that there is no area to be allocated to the log file. Accordingly, when the page number of the log file calculated in step S232 is greater than the maximum used page number of the log area management table 21, the resource management program 16 determines whether there is a log file that can be subsequently allocated (S234).

Meanwhile, in step S233, when the page number of the log file calculated in step S232 is smaller than the maximum used page number of the log area management table 21, the resource allocation program 16 uses the next page number of the log file as the page number to be allocated to the update sub thread (S236).

In step S234, when it is determined that there is a log file that can be allocated subsequently, the resource allocation program 16 uses the next page number of the log file as the page number to be allocated to the update sub thread (S235).

Subsequently, the resource allocation program 16 updates the area number to which the maximum used page number of the corresponding log file of the log area management table 21 was allocated (S237).

Subsequently, the resource allocation program 16 sets, in the log area 226 of the update sub thread to which the log area of the thread management table 22 was allocated, the log area number corresponding to the page number that was allocated in step S235 or step S236 (S237).

Meanwhile, when it is determined in step S234 that there is no log file that can be allocated subsequently, the resource allocation program 16 clears the value of the log area number of the thread management table 22 (S239).

While log data is added to the log area in the foregoing log area allocation processing, the configuration is not limited thereto, and the log data may also be overwritten in the log area.

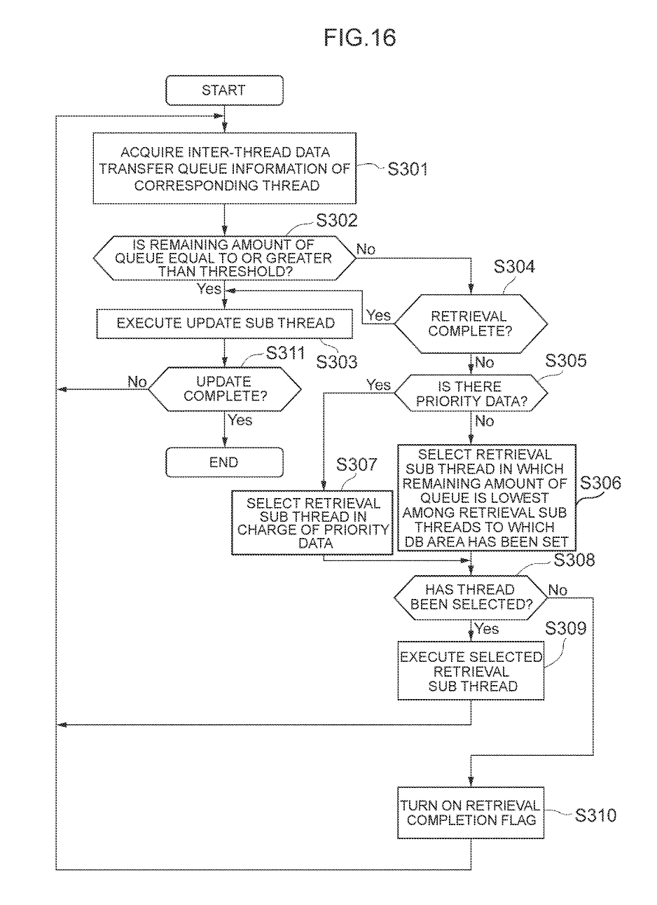

The sub thread execution control processing based on the sub thread execution control program 17 is now explained with reference to FIG. 16. The sub thread execution control processing is processing of controlling, when a thread is executed under the control of the OS of the host computer 1, the execution of the sub thread associated with that thread.

In the sub thread execution processing explained below, the update processing is executed by executing the update sub thread when there are a predetermined number of queues to be updated in the inter-thread data transfer queue 23, and the retrieval processing is executed by executing the retrieval sub thread when there are not queues to be updated in the inter-thread data transfer queue 23. As described above, since the update sub thread and the retrieval sub thread are respectively associated with a specific DB area or a specific log area, the update processing or the retrieval processing based on a sub thread can be executed in parallel.

As shown in FIG. 16, the sub thread execution control program 17 acquires the number of the thread to be executed from the OS of the host computer 1, and acquires information of the inter-thread data transfer queue 23 corresponding to that thread (S301).

Subsequently, the sub thread execution control program 17 determines whether the remaining amount of the inter-thread data transfer queue 23 acquired in step S301 is equal to or greater than a predetermined threshold (S302).

When it is determined in step S302 that the remaining amount of the inter-thread data transfer queue 23 is equal to or greater than a predetermined threshold, the sub thread execution control program 17 executes the data update sub thread (S303). Specifically, the sub thread execution control program 17 executes the data update sub thread corresponding to the To thread number of the inter-thread data transfer queue 23, and updates the DB area or the log area associated with the data update sub thread to be executed based on the record value of the inter-thread data transfer queue 23.

Subsequently, the sub thread execution control program 17 determines whether the update processing of the inter-thread data transfer queue 23 is complete (S311), When the update is not complete, the processing of step S301 onward is repeated. Meanwhile, when it is determined in step S311 that the update processing is complete, the sub thread execution control program 17 and the processing.

Meanwhile, when it is determined in step S302 that the remaining amount of the inter-thread data transfer queue 23 is less than a predetermined threshold, the sub thread execution control program 17 determines whether the retrieval processing based on the retrieval sub thread is complete (S304).

When it is determined in step S304 that the retrieval processing based on the retrieval sub thread is complete, the sub thread execution control program 17 performs the execution processing of the data update sub thread of step S303.

Meanwhile, when it is determined in step S304 that the retrieval processing based on the retrieval sub thread is not complete, the sub thread execution control program 17 determines whether there is data to be retrieved preferentially (S305).

When it is determined in step S305 that there is data to be retrieved preferentially, the sub thread execution control program 17 selects the sub thread to handle the retrieval processing of the preferential data (S307). Meanwhile, when it is determined in step S305 that there is no data to be retrieved preferentially, the sub thread execution control program 17 selects the retrieval sub thread in which the remaining amount of queues is the lowest among the retrieval sub threads to which a DB area has been set (S306).

Subsequently, the sub thread execution control program 17 determines whether a sub thread has been selected (S308), executes the retrieval sub thread when the sub thread has been selected (S309), and repeats the processing of step S301 onward. Meanwhile, when a sub thread has not been selected in step S308, the sub thread execution control program 17 turns ON the retrieval completion flag and repeats the processing of step S301 onward.

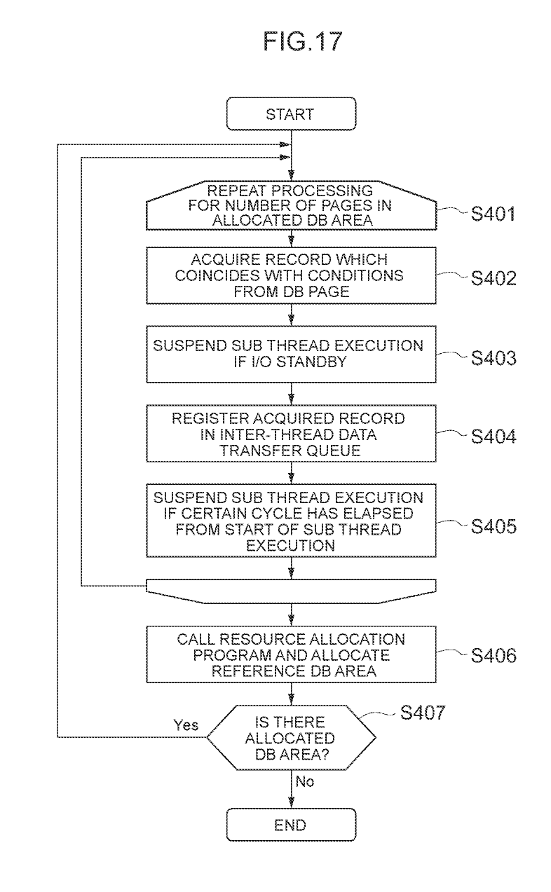

The DB retrieval processing based on the DB retrieval program 18 is now explained with reference to FIG. 17. The DB retrieval processing is processing that is started by the sub thread execution control program 17 selecting the retrieval sub thread with regard to the retrieval sub thread to which a resource has been allocated based on the foregoing resource allocation processing.

As shown in FIG. 17, the DB retrieval program 18 repeats the processing of step S402 to step S405 for the number of pages in the DB area which has been allocated to the retrieval sub thread to be executed (S401).

The DB retrieval program 18 acquires a record which coincides with the retrieval conditions from the DB page of the DB area which has been allocated to the retrieval sub thread to be executed (S402). When the record acquired in step S402 will be in a state of I/O standby, the execution of the retrieval sub thread is suspended (S403).

Subsequently, the DB retrieval program 18 registers the record acquired in step 3402 in the inter-thread data transfer queue 23 (S404). Specifically, the DB retrieval program 18 registers the number of the executed retrieval sub thread in the From thread number 231 of the inter-thread data transfer queue 23, registers the number of the update sub thread to be executed in the same thread as the retrieval sub thread in the To thread number 232, and records the record value acquired in step S402 in the record value 233.

The DB retrieval program 18 suspends the execution of the retrieval sub thread when a certain cycle has elapsed from the time that the execution of the retrieval sub thread was started (S405). Based on the suspension processing of step S405, it is possible to prevent the retrieval processing of one retrieval sub thread from being executed for a long period within one thread, and prevent the other retrieval sub threads from not being executed and continuing to be in a standby state.

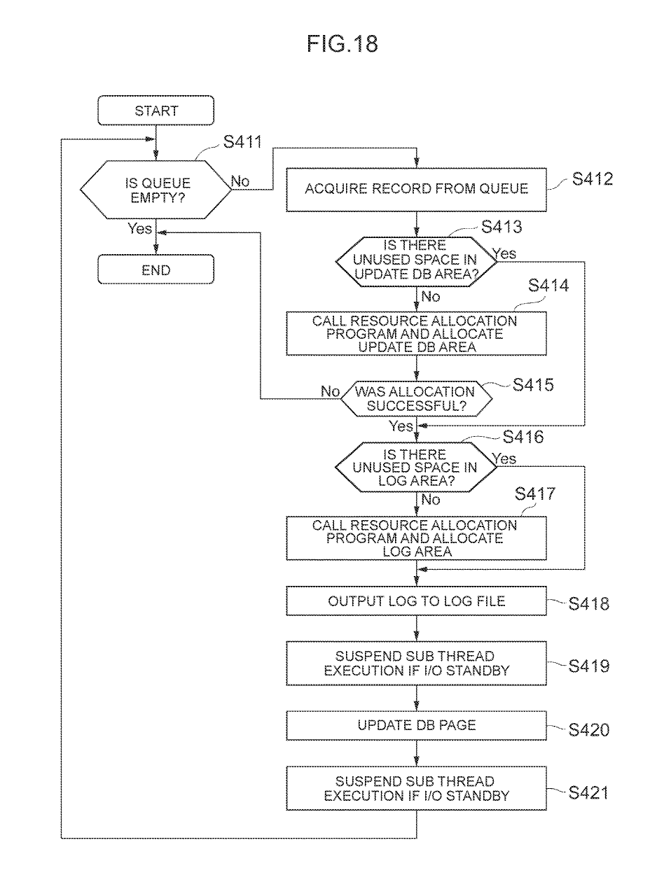

The DB update processing based on the DB update program 19 is now explained with reference to FIG. 18. The DB update processing is processing of updating the data corresponding to the record of the queue registered in the inter-thread data transfer queue 23 based on the foregoing DB retrieval processing.

As shown in FIG. 18, the DB update program 19 determines whether the inter-thread data transfer queue 23 is empty (S411). When the inter-thread data transfer queue 23 is empty in step S411, the DB update program 19 ends the processing.

Meanwhile, when it is determined in step S411 that the inter-thread data transfer queue 23 is not empty, the DB update program 19 acquires a record from the inter-thread data transfer queue 23 (S412).

Subsequently, the DB update program 19 determines whether there is space in the update DB area that was associated with the update sub thread being executed (S413).

When it is determined in step S413 that there is space in the update DB area, the processing of step S416 is executed. Meanwhile, when it is determined in step S413 that there is no space in the update DB area, the foregoing resource allocation program 16 is called and a new update DB area is allocated to the update sub thread (S414).

When the allocation processing of step S414 is successful (S415), the DB update program 19 executes the processing of step S416. Meanwhile, when the allocation processing of step S414 is unsuccessful (S415), the DB update program 19 ends the processing.

In step S416, the DB update program 19 determines whether there is space in the log area that was associated with the update sub thread being executed (S416).

When it is determined in step S416 that there is space in the log area, the processing of step S418 is executed. Meanwhile, when it is determined in step S416 that there is no space in the log area, the foregoing resource allocation program 16 is called and a new log area is allocated to the update sub thread (S417).

In step S418, the DB update program 19 outputs the log to the log file which has been associated with the update sub thread (S418). The DB update program 19 suspends the execution of the update sub thread when the output processing of the log to the log file will be in a state of I/O standby (S419).

Next, the DB update program 19 updates the DB page which was associated with the update sub thread (S420). The DB update program 10 suspends the execution of the update sub thread when the output processing to the DB file to be updated will be in a state of I/O standby (S421). After completing the update of the DB file to be updated, the DB update program 19 repeats the processing of step S411 onward.

The common resource update processing in the host computer 1 was explained above. Next, the management screen 90 of the management terminal 8 is explained. Upon executing the common resource update processing in the host computer 1 described above, data to be preferentially retrieved and the number of retrieval sub threads may be set in advance.

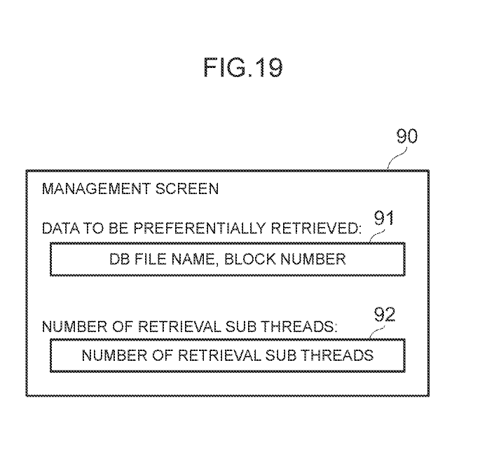

For example, the management screen 90 shown in FIG. 19 is provided with an input field 91 for inputting information of data to be preferentially retrieved, and an input field 92 for inputting the designated number of the retrieval sub threads.

The input field 91 is input with the DB file name or the block number as the information of data to be preferentially retrieved. Moreover, the input field 92 is input with the number of retrieval sub threads.

(4) Effect of This Embodiment

As described above, according to this embodiment, the process of the host computer 1 controls the execution of a program configured from a plurality of threads, and updates a common resource including a plurality of areas associated with the plurality of threads. Specifically, the processor causes at least one sub thread among a plurality of sub threads to be an update sub thread which updates an area of the common resource associated with the sub thread, causes a sub thread that is different from the update sub thread to be a reference thread which sends an update request to the update thread upon updating the common resource, and directly refers to the common resource upon referring to the common resource. It is thereby possible to logically divide a common resource to be updated among the respective sub threads and perform the update processing in parallel among a plurality of cores, and thereby improve the update processing performance.

### REFERENCE SIGNS LIST

1: host computer
2: storage apparatus
3: data network
4: logical disk
5: logical volume
6: DB file
7: log file
8: management terminal

1. A common resource updating apparatus, comprising:
a processor which controls an execution of a program configured from a plurality of threads, and updates a common resource including a plurality of areas associated with the plurality of threads,
wherein the processor:
causes at least one thread among the plurality of threads to be an update thread which updates an area of the common resource associated with the thread; and
causes a thread that is different from the update thread to be a reference thread which sends an update request to the update thread upon updating the common resource, and directly refers to the common resource upon referring to the common resource.

2. The common resource updating apparatus according to claim 1,
wherein the processor:
causes one area among the plurality of areas of the common resource to be an area to be updated by the update thread, and causes the other areas to be areas to be referred to by the reference thread.

3. The common resource updating apparatus according to claim 1,
wherein the processor:
stores the update request sent from the reference thread to the update thread in a data transfer queue, and causes the update thread to update the areas of the common resource according to an order stored in the data transfer queue.

4. The common resource updating apparatus according to claim 1,
wherein the processor:
controls a plurality of cores which share the common resource and process the plurality of threads in parallel; and
wherein one thread among the plurality of threads executed by the plurality of cores includes at least one of the update threads and a plurality of the reference threads.

5. The common resource updating apparatus according to claim 4,
wherein the processor:
associates the one thread among the plurality of threads executed by the plurality of cores, at least one of the update threads included in the thread, and the areas of the common resource to be updated by the update thread.

6. The common resource updating apparatus according to claim 5,
wherein the processor:
associates the one thread among the plurality of threads executed by the plurality of cores, the plurality of the reference threads included in the thread, and the areas of the common resource to be updated by the update thread.

7. A common resource updating method in a common resource updating apparatus which controls an execution of a program configured from a plurality of threads, and updates a common resource including a plurality of areas associated with the plurality of threads,
wherein at least one update thread and a plurality of reference threads are included in one thread among the plurality of threads, and the update thread and an area of the common resource to be updated by the update thread are associated,
wherein the common resource updating method comprises:
a step of the reference thread sending an update request to the update thread upon updating the common resource;
a step of the reference thread directly referring to the common resource upon referring to the common resource;
a step of the update thread storing the sent update request in a data transfer queue; and
a step of the update thread updating the areas of the common resource according to an order stored in the data transfer queue.

8. The common resource updating method according to claim 7,
wherein one area among the plurality of areas of the common resource is an area to be updated by the update thread, and the other areas are areas to be referred to by the reference thread.

9. The common resource updating method according to claim 7,
wherein a plurality of cores which share the common resource and process the plurality of threads in parallel, one thread among the plurality of threads executed by the plurality of cores, and the update thread or the reference thread are associated.

10. The common resource updating method according to claim 9,
wherein the update thread and the areas of the common resource to be updated by the update thread are associated, and the reference thread and the areas of the common resource to be referred by the reference thread are associated.
